(19) United States
(12) Patent Application Publication
(10) Pub. No.: US 2012/0324400 A1
(43) Pub. Date: Dec. 20, 2012

(54) Rotation Of Multi-Workspace Environment Containing Tiles

(76) Inventors: Neal Robert Caliendo, JR., Raleigh, NC (US); Lisa Louise Carter, Durham, NC (US); Russell Stuart Gantman, Fuquay-Varina, NC (US); Paul Plaskonos, Raleigh, NC (US); Adam Miles Smith, Chapel Hill, NC (US); Russell Speight VanBlon, Raleigh, NC (US)

(21) Appl. No.: 13/160,706

(22) Filed: Jun. 15, 2011

(51) Int. Cl. G06F 3/048

(52) U.S. Cl. 715/835

(57) ABSTRACT

According to one disclosed embodiment, an approach is provided to rotate a workspace displayed on a display screen. The workspace includes visual tiles displayed in a grid layout of columns and rows. A current aspect ratio of the display screen is identified. A current row value and a current column value associated with each of the visual tiles is retrieved. The current aspect ratio is inverted resulting in a new aspect ratio of the display screen. Each of the plurality of visual tiles is rotated ninety degrees. A new row value associated with each of the visual tiles is set to the current column value and a new column value associated with each of the visual tiles is set to the current row value. Each rotated tile is displayed at the new row and column values using the new aspect ratio.

### BACKGROUND

The present invention relates to an approach that allow rotation of tiles within a workspace, such as found in a handheld computing device.

Pervasive, generally portable, information handling systems such as mobile telephones (e.g., “smart phones,” etc.) provide increasing amounts of performance and power in small, generally handheld, form factors. Software applications are represented as visual graphical user interface objects called “tiles” on the pages, or workspaces, provided by the information handling system. Tiles are graphic user interfaces that often also provide small textual titles that describe the underlying application. In addition, these pervasive information handling system often use touch-enabled screens to save space without providing traditional keypads or keyboards as generally found as accessories in laptop and desktop computer systems. Users often organize workspaces by placing related applications on a common page. For example, a user may have a workspace of games, another workspace with utilities, another workspace with entertainment, and the like. The screen provided with these pervasive information handling system are often a non-square rectangle where one of the dimensions (e.g., length) being greater than the other dimension (e.g., width).

### BRIEF SUMMARY

According to one disclosed embodiment, an approach is provided in which a workspace rotation request is received, the request being to rotate a workspace displayed on a display screen. The workspace includes visual tiles that are displayed in a grid layout of one or more columns and one or more rows. A current aspect ratio of the display screen is identified. A current row value and a current column value associated with each of the visual tiles is retrieved. The current aspect ratio is inverted resulting in a new aspect ratio of the display screen. Each of the plurality of visual tiles is rotated ninety degrees. A new row value associated with each of the visual tiles is set to the current column value and a new column value associated with each of the visual tiles is set to the current row value. Each of the rotated plurality of visual tiles is displayed on the display screen at the new row value and new column value set for each of the visual tiles using the new aspect ratio.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing a workspace being rotated between landscape and portrait orientations with aspect ratios adjusted accordingly;

FIG. 4 is a flowchart showing the steps performed when rotating the workspace between the portrait and landscape orientations;

FIG. 5 is a flowchart showing the steps performed to display the workspace in a rotated (landscape or portrait) orientation;

FIG. 6 is a flowchart showing the steps performed to retrieve the column and rows of items appearing on the display screen; and

FIG. 7 is a flowchart depicting the column and row swapping aspects as well as examples of data values stored in the various data stores.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

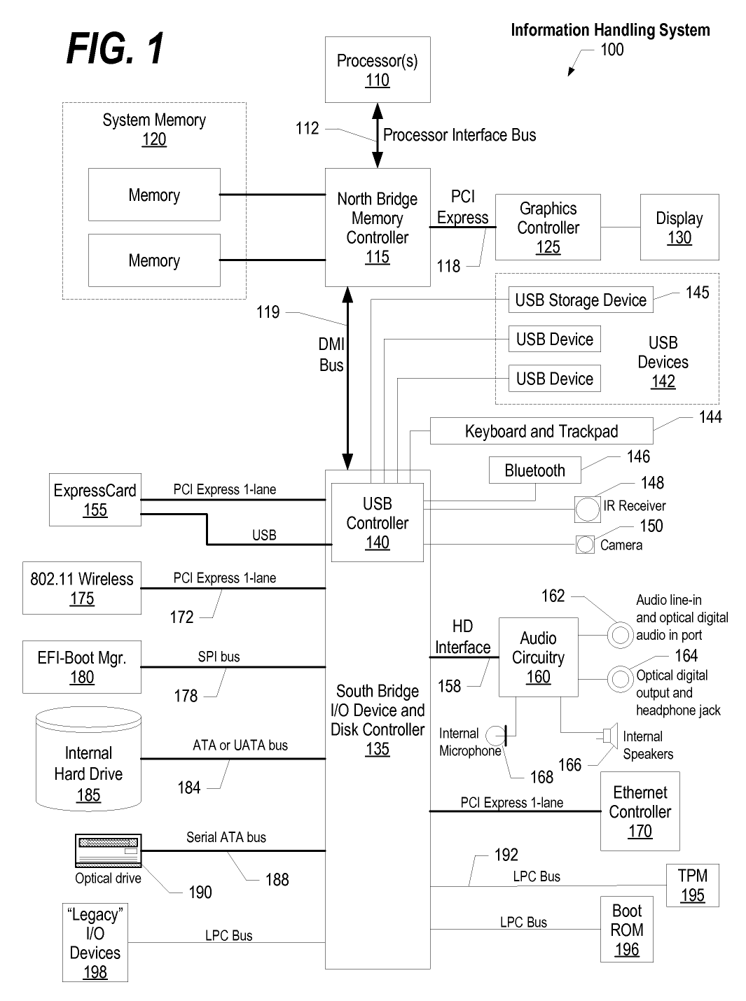

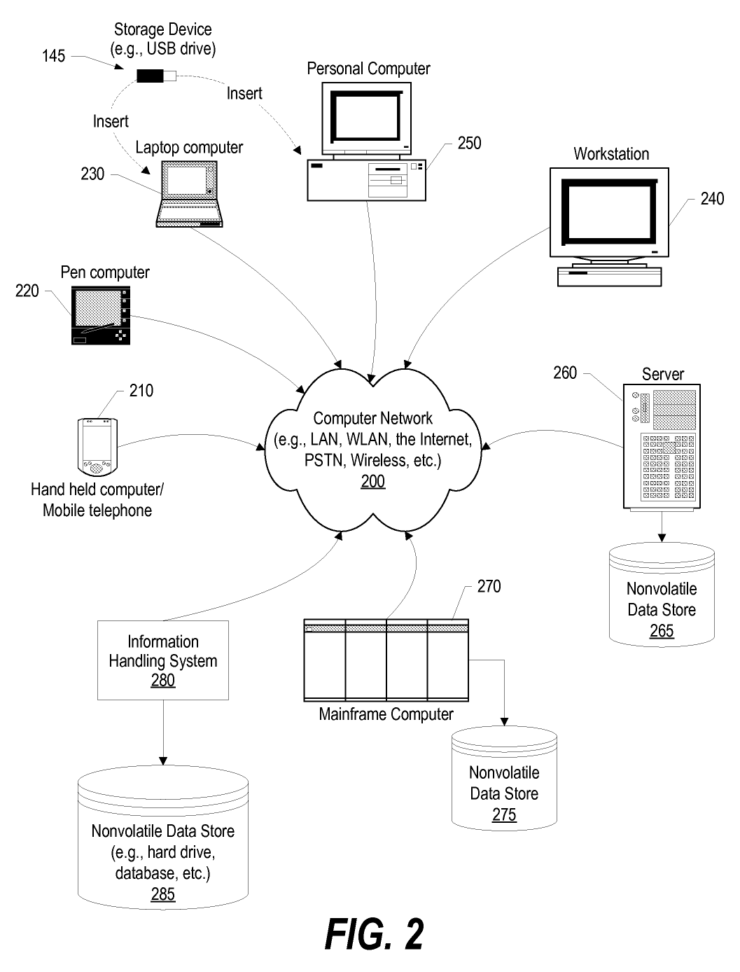

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

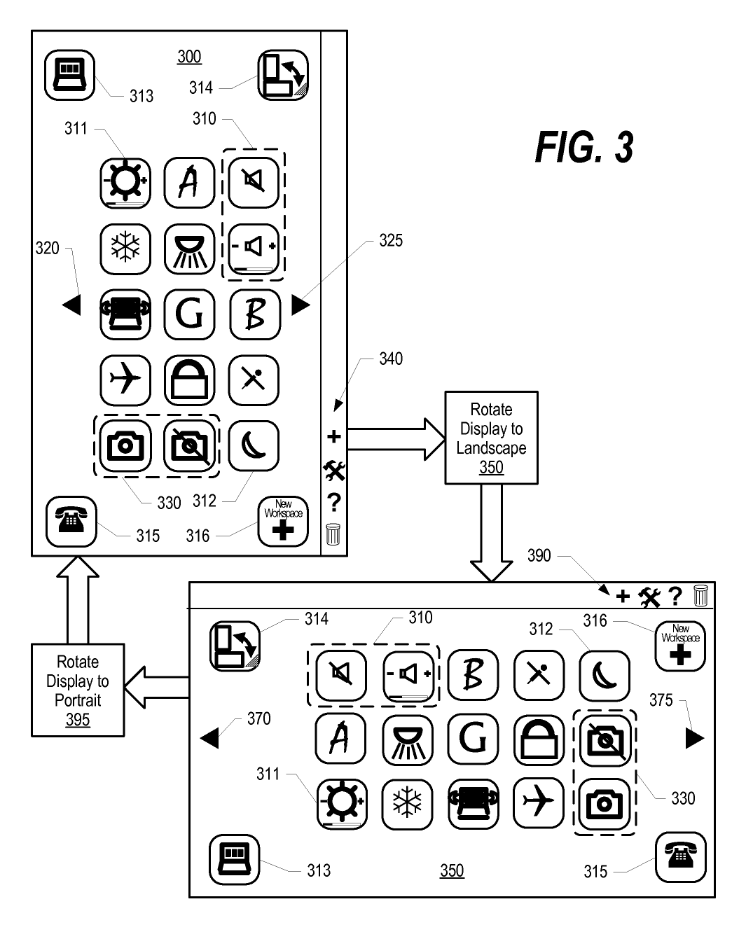

FIG. 3 is a diagram showing a workspace being rotated between landscape and portrait orientations with aspect ratios adjusted accordingly. Portrait orientation 300 shows the display screen with the height of the screen greater than the width of the screen. The workspace displayed includes a number of visual tiles in various positions on the display. In the example shown, free-form tiles have been positioned by the user into corner spaces on the display. These free-form tiles include tiles 313, 314, 315, and 316. The remainder of the tiles, including tiles 311 and 312, occupy a center area of the display. In one embodiment, the tiles positioned in the center area are in fixed rows and columns while the free-form tiles are freely positioned by the user. In this manner, the user can configure the display so that more or less of the display area is used to display fixed rows with the remaining area (or no area whatsoever) used for free-form positioned tiles. Portrait orientation 300 also includes toolbar 340 which is positioned along the side of the display (in this case the right side) as well as horizontal scroll features (arrows 320 and 325) that allow the user to scroll to additional workspaces that occur either logically before or after the displayed workspace. In one embodiment the display is a touch-enabled display that allows the user to scroll left and right using a gesture (e.g., sliding a thumb or other digit left or right across the touch-enabled display to scroll left or right, etc.). Two or more adjacent tiles may be visually grouped together, such as visual groupings 310 and 330. In one embodiment, the visual grouping is performed by displaying a visual outline around the set of grouped tiles, such as the outline shown in visual groupings 310 and 330.

At some point, a workspace rotation request is received to rotate the displayed workspace (step 350). In one embodiment, the request is received in response to the user selecting rotation tile 314. When the workspace rotation request is received, the system identifies a current aspect ratio that is currently being used to display portrait orientation 300. A current row value and column value is retrieved for each of the visual tiles shown in portrait orientation workspace 300. In one embodiment, rows and columns can overlap. For example, tiles 314 and 316 are shown as overlapping the tiles included in visual grouping 310. A new aspect ratio is generated by inverting the current aspect ratio. For example, if the current resolution used to display the portrait mode is 1080×1920 providing an aspect ratio of 1:1.78, then the inverted aspect ratio would be 1.78:1 and the resulting resolution would be 1920×1080. The new aspect ratio is used to display the rotated workspace (landscape orientation 350). Each of the visual tiles is rotated ninety degrees in a direction opposite to the rotation of the workspace. For example, if the workspace is being rotated ninety degrees counterclockwise, then each of the visual tiles is rotated ninety degrees in a clockwise direction for display in rotated (landscape orientation) workspace 350. The current column values from current (portrait) orientation workspace 300 become new row values in new (landscape) orientation workspace 350, while the current row values from current (portrait) orientation workspace 300 become new column values in new (landscape) orientation workspace 350. In other words, tiles displayed in common columns in portrait orientation 300 are displayed in common rows in landscape orientation 350 and, at the same time, tiles displayed in common rows in portrait orientation 300 are displayed in common columns in landscape orientation 350.

Turning to landscape orientation 350, notice that each of the visual tiles from portrait orientation 300 is now displayed at the new row and column values that were set for each tile, each of the visual tiles has been rotated, and landscape orientation 350 uses the new aspect ratio that resulted by inverting the aspect ratio used to display portrait orientation 300. In addition, tiles that used to occupy the same column in portrait orientation 300 (e.g., tiles 314 and 316) now occupy the same row in landscape orientation 350. Likewise, tiles that appeared in a common row in the portrait orientation (e.g., tiles 313 and 314) now appear in a common column in landscape orientation. In addition, visual groupings that appeared in a common column in portrait orientation 300 (e.g., visual grouping 310), now appear in a common row in landscape orientation, while those visual groupings that appeared in a common row (e.g., visual grouping 330) in the portrait orientation now appear in a common column. Horizontal scroll features are not swapped like the visual tiles. Instead, if horizontal scroll features appear in the portrait orientation, such as horizontal scroll features 320 and 325, then horizontal scroll features also appear in the landscape orientation (e.g., horizontal scroll features 370 and 375). In one embodiment, toolbar 340 and the icons included in the toolbar are rotated much like the tiles described above, while in another embodiment the presence of the toolbar is detected when the workspace is rotated and presented in a place suitable for the new orientation (e.g., at the top or bottom of the landscape orientation). In addition, placement of the toolbar can, in some embodiments, be configured by the user. When another request is received (step 395) to rotate the workspace once again, the steps described above are used to invert the aspect ratio, rotate the tiles, etc. to once again display portrait orientation 300.

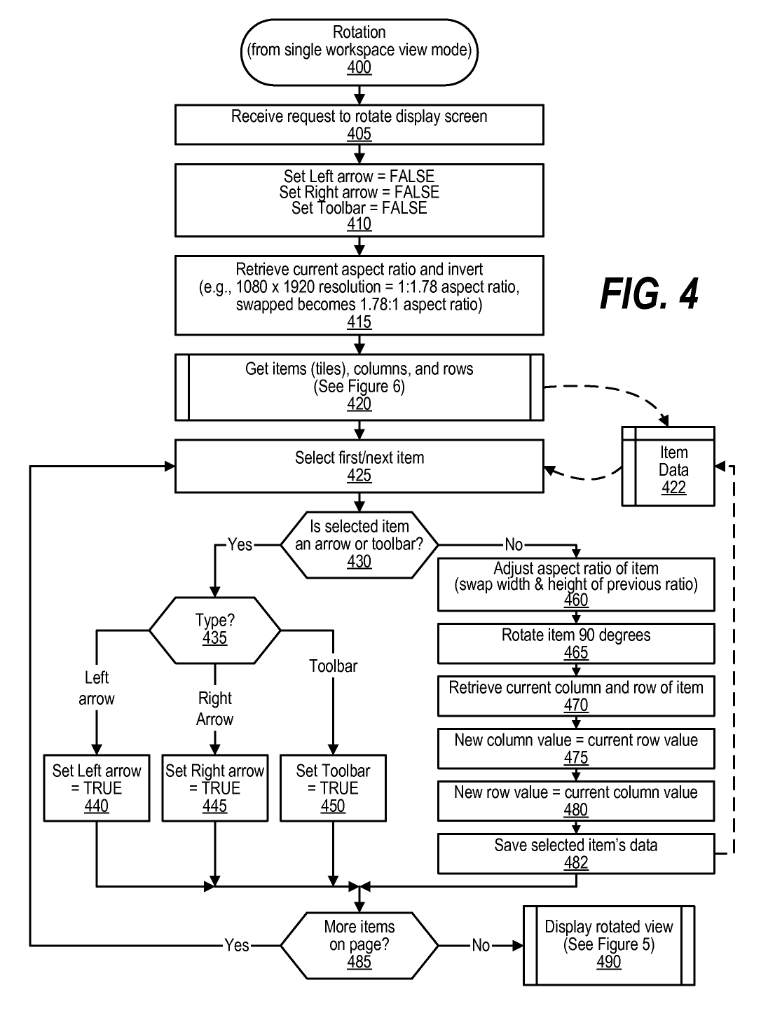

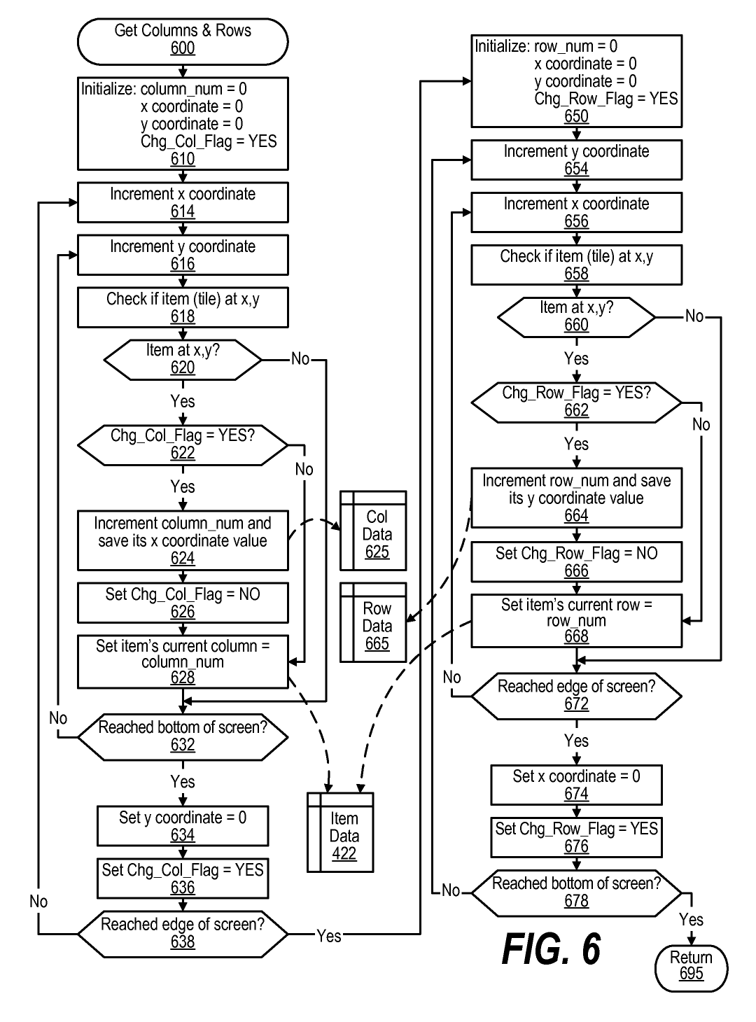

FIG. 4 is a flowchart showing the steps performed when rotating the workspace between the portrait and landscape orientations. Processing commences at 400 whereupon, at step 405, a request is received to rotate a workspace currently displayed on a display screen, such as by receiving a user request resulting from a user selecting rotation tile 314 shown in FIG. 3. At step 410, some values are initialized to FALSE until such items are detected on the workspace. These items include a left arrow (left scroll feature), a right arrow (right scroll feature), and a toolbar. At step 415, the current aspect ratio currently being used display the workspace is retrieved and inverted. For example, if the current resolution is 1080 by 1920 the aspect ratio is 1:1.78 and, inverted, the new aspect ratio is 1.78:1. At predefined process 320, the items (visual tiles, etc.) currently appearing in the workspace are retrieved and data, such as row and column positions, about these items is stored in memory area 422 (see FIG. 6 and corresponding text for processing details).

At step 425, the first item is selected from memory area 422. A decision is made as to whether the selected item is a horizontal scroll feature (arrow) or a toolbar (decision 430). If the selected item is a horizontal scroll feature (arrow) or a toolbar, then decision 430 branches to the “yes” branch whereupon a decision (select case) is made as to the type of the item. If the item is a left arrow (left horizontal scroll feature), then the select case branches to the “left arrow” branch whereupon, at step 440, the flag is set to indicate that a left horizontal scroll feature is present. If the item is a right arrow (right horizontal scroll feature), then the select case branches to the “right arrow” branch whereupon, at step 445, the flag is set to indicate that a right horizontal scroll feature is present. Finally, if the item is a toolbar, then the select case branches to the “toolbar” branch whereupon, at step 450, the flag is set to indicate that a toolbar is present.

Returning to decision 430, if selected item is not an arrow (horizontal scroll feature) or a toolbar, then decision 430 branches to the “no” branch to process the selected tile. At step 460, the aspect ratio used to display the tile is adjusted by inverting the current aspect ratio. At step 465, the tile is rotated ninety degrees in a direction opposite to the rotation of the workspace. For example, if the workspace is being rotated ninety degrees counterclockwise, then the tile is rotated ninety degrees in a clockwise direction. At step 470, the current column value and row value of the tile are retrieved from item data 422. At step 475, the tile's new column value is set to be its current row value and, at step 480, the tile's new row value is set to be its current column value. At step 482, the tile's adjusted data is saved in item data memory area 422.

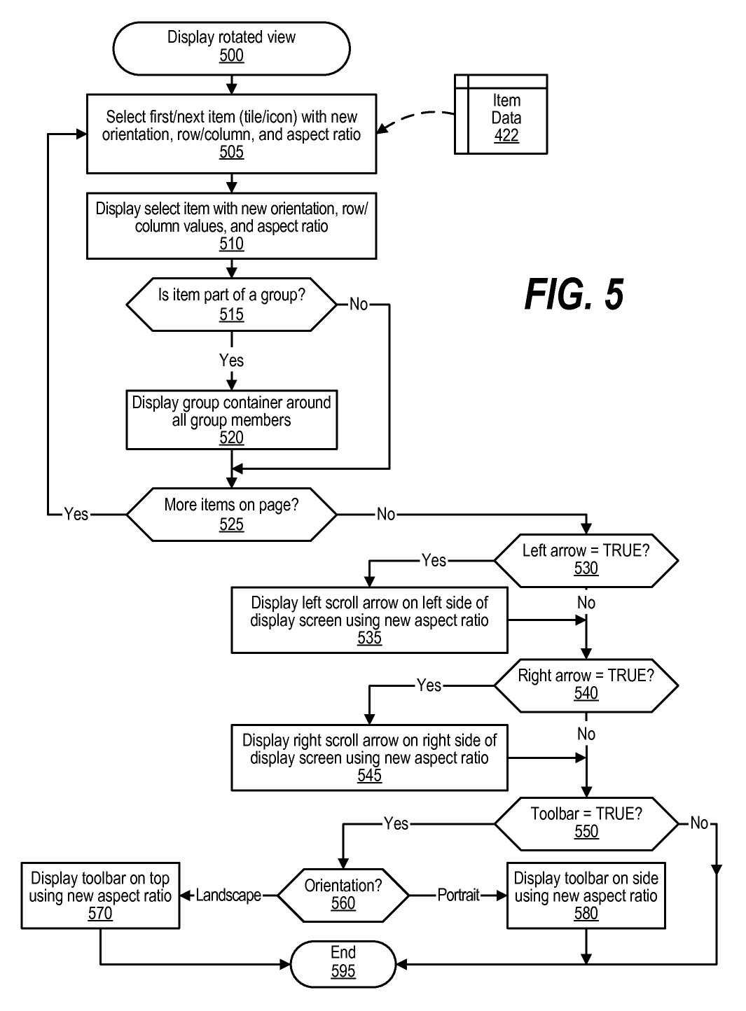

A decision is made as to whether there are more items on the current workspace to process (decision 485). If there are additional items to process, then decision 485 branches to the “yes” branch which loops back to select and process the next item as described above. This looping continues until all of the items have been processed, at which point decision 485 branches to the “no” branch whereupon, at predefined process 490, the rotated view is displayed on the display screen (see FIG. 5 and corresponding text for processing details).

FIG. 5 is a flowchart showing the steps performed to display the workspace in a rotated (landscape or portrait) orientation. Processing commences at 500 whereupon, at step 505, the first item is selected from item data memory area 422 with the item's new orientation, row/column, and aspect ratio. At step 510, the selected item is displayed with the new orientation (rotated), row/column values, and aspect ratio. A decision is made as to whether the selected item is part of a group (decision 515). If the selected item is part of a group then, when the last item of the group is displayed then a visual grouping is displayed around all of the tiles belonging to the group. A decision is made as to whether there are more items to process (decision 525). If there are more items (tiles) to process, then decision 525 branches to the “yes” branch which loops back to select the next item from memory area 422. This looping continues until all of the items have been processed, at which point decision 525 branches to the “no” branch for further processing.

A decision is made as to whether the left arrow (left horizontal feature) flag has been set (decision 530). If the flag has been set, then decision 530 branches to the “yes” branch whereupon, at step 535, the left horizontal feature (e.g., flag) is displayed on the left side of the display screen using the new aspect ratio. A decision is made as to whether the right arrow (right horizontal feature) flag has been set (decision 540). If the flag has been set, then decision 540 branches to the “yes” branch whereupon, at step 545, the right horizontal feature (e.g., flag) is displayed on the right side of the display screen using the new aspect ratio. A decision is made as to whether is made as to whether a toolbar was detected (decision 550). If a toolbar was detected, then decision 550 branches to the “yes” branch whereupon a decision is made as to whether the new orientation of the workspace is landscape or portrait (decision 560). If the new orientation is landscape, then decision 560 branches to the “landscape” branch whereupon, at step 570, the toolbar is displayed on the top (or the bottom) of the screen. On the other hand, if the new orientation is portrait, then decision 560 branches to the “portrait” branch whereupon, at step 580, the toolbar is displayed along the side of the screen (either the left or right side). On the other hand, returning to decision 550, if a toolbar was not detected, then decision 550 branches to the “no” branch bypassing steps 560 through 580. Processing then ends at 595.

FIG. 6 is a flowchart showing the steps performed to retrieve the column and rows of items appearing on the display screen. In one embodiment, columns are retrieved by scanning the display screen horizontally (e.g., from left to right, etc.) while rows are retrieved by scanning the display screen vertically (e.g., from top to bottom, etc.). At step 610, values are initiated to begin the process of scanning for columns. In particular, the current column number (column_num) is set to zero as are the current x and y coordinates. In addition, a flag (Chg_Col_Flag) is set indicating that when a tile is encountered the column number should be incremented and the x coordinate corresponding to the column should be saved. At step 614 the x coordinate value is incremented. The incrementing can be by any value (e.g., one pixel, ten pixels, fifty pixels, etc.) and sets the granularity of column positions. Likewise, at step 616 the y coordinate value is incremented. Again, the incrementing can be by any value (e.g., one pixel, ten pixels, fifty pixels, etc.) and sets the granularity of row positions. In one embodiment, the value used to increment the x and y values is the same value. At step 618, a check is made to identify if a tile is present at the x,y coordinate value. A decision is made as to whether a tile is present at the x,y coordinate value (decision 620). If a tile is at the x,y coordinate value, then decision 620 branches to the “yes” branch whereupon a decision is made as to whether the column change flag (Col_Chg_Flag) is set to YES or NO (decision 622). Logic is also included so that a tile is only detected once per column scan. If the column change flag is set to yes, then decision 622 branches to the “yes” branch whereupon, at step 624, the current column number (column_num) is incremented (e.g. by one) and column number along with the x value corresponding to this column number are saved in column data memory area 625. At step 626, the change column flag is set to NO. Returning to decision 622, if the change column flag is set to NO, then decision 622 branches to the “no” branch bypassing steps 624 and 626. At step 628, the tile that has been detected has its current column number set to the current column number (column_num) and the tile identifier and its column number are saved in item data store 422.

A decision is made as to whether the scan has reached the bottom of the screen given the screen's resolution (decision 632). If the scan has not yet reached the bottom of the screen, then decision 632 branches to the “no” branch which loops back to increment the y coordinate value and repeat the process described above. This looping continues until the bottom of the screen is reached, at which point decision 632 branches to the “yes” branch whereupon, at step 634 the y coordinate value is reset to zero, and at step 636, the change column flag (Chg_Col_Flag) is set to YES. A decision is made as to whether the scan has reached the edge of the screen (decision 638). When the edge of the screen is reached, there are no more columns to detect. If the scan has not yet reached the edge of the screen, then decision 638 branches to the “no” branch which loops back to increment the x coordinate value and repeat the scanning process outlined above. This looping continues until all of the columns have been detected, at which point decision 638 branches to the “yes” branch in order to commence the row scanning process.

At step 650, values are initiated to begin the process of scanning for rows. In particular, the current row number (row_num) is set to zero as are the current x and y coordinates. In addition, a flag (Chg_Row_Flag) is set indicating that when a tile is encountered the row number should be incremented and the y coordinate corresponding to the row should be saved. At step 654 the y coordinate value is incremented. The incrementing can be by any value (e.g., one pixel, ten pixels, fifty pixels, etc.) and sets the granularity of row positions. Likewise, at step 656 the x coordinate value is incremented. Again, the incrementing can be by any value (e.g., one pixel, ten pixels, fifty pixels, etc.) and sets the granularity of column positions. In one embodiment, the value used to increment the y and x values is the same value. At step 658, a check is made to identify if a tile is present at the x,y coordinate value. A decision is made as to whether a tile is present at the x,y coordinate value (decision 660). If a tile is at the x,y coordinate value, then decision 660 branches to the “yes” branch whereupon a decision is made as to whether the row change flag (Row_Chg_Flag) is set to YES or NO (decision 662). Logic is also included so that a tile is only detected once per row scan. If the row change flag is set to yes, then decision 662 branches to the “yes” branch whereupon, at step 664, the current row number (row_num) is incremented (e.g. by one) and row number along with the y value corresponding to this row number are saved in row data memory area 665. At step 666, the change row flag is set to NO. Returning to decision 662, if the change row flag is set to NO, then decision 662 branches to the “no” branch bypassing steps 664 and 666. At step 668, the tile that has been detected has its current row number set to the current row number (row_num) and the tile identifier and its row number are saved in item data store 422.

A decision is made as to whether the scan has reached the edge of the screen given the screen's resolution (decision 672). If the scan has not yet reached the edge of the screen, then decision 672 branches to the “no” branch which loops back to increment the x coordinate value and repeat the process described above. This looping continues until the edge of the screen is reached, at which point decision 672 branches to the “yes” branch whereupon, at step 674 the x coordinate value is reset to zero, and at step 676, the change row flag (Chg_Row_Flag) is set to YES. A decision is made as to whether the scan has reached the bottom of the screen (decision 678). When the bottom of the screen is reached, there are no more rows to detect. If the scan has not yet reached the bottom of the screen, then decision 678 branches to the “no” branch which loops back to increment the y coordinate value and repeat the scanning process outlined above. This looping continues until all of the rows have been detected, at which point decision 678 branches to the “yes” branch at which point processing returns to the calling routine (see FIG. 4) at 695.

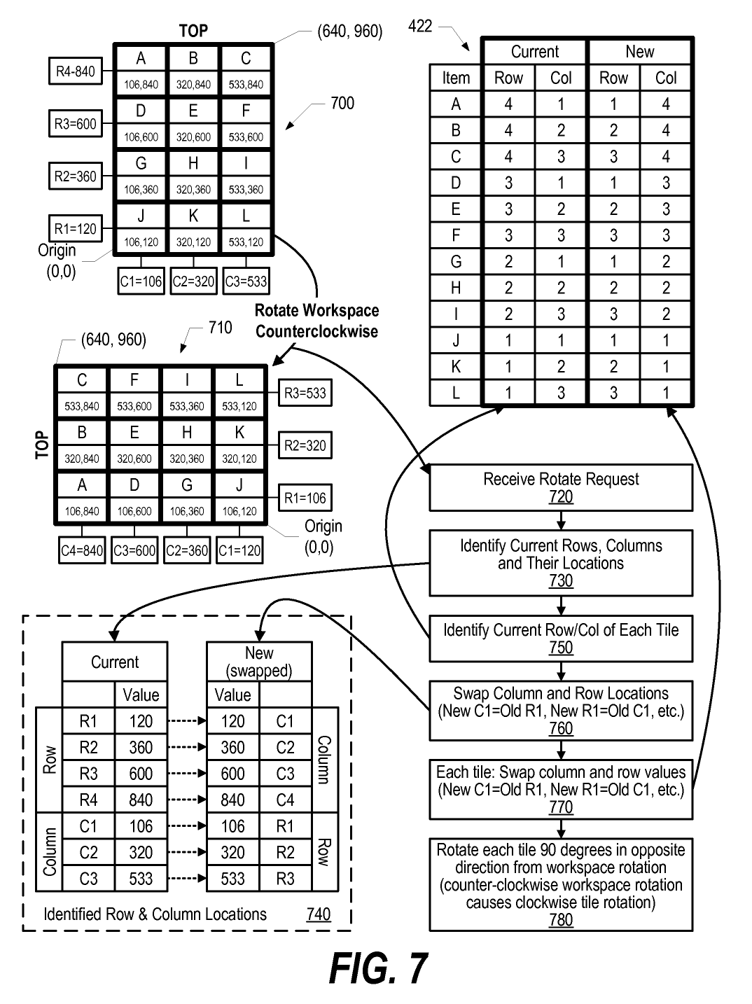

FIG. 7 is a flowchart depicting the column and row swapping aspects as well as examples of data values stored in the various data stores. Portrait orientation 700 shows an example of twelve tiles (A through L) being displayed on a screen with a 640 by 960 resolution. The tiles are arranged three across by four down with the midpoint coordinates of each tile shown below the respective tile. The resulting four row values (R1 through R4) are shown on the left side and the resulting three column values (C1 through C3) are shown at the bottom of the display screen. Landscape orientation 710 shows the same twelve tiles after the workspace has been rotated counterclockwise by ninety degrees. Note that each tile has been rotated clockwise by ninety degrees. The origin (0,0) remains at the same physical location of the screen so the origin is rotated counterclockwise when the workspace is rotated counterclockwise. In landscape mode 710 the tiles are now arranged four across by three down with the midpoint positions of each tile again shown beneath the respective tiles. The resulting three row values (R1 through R3) are shown on the right side and the resulting four column values (C1 through C4) are shown at the bottom. Item data memory area 422 is shown with values corresponding to the rows and columns depicted in examples 700 and 710. Current values (row and column) correspond to the twelve tiles in example portrait orientation 700 while the new values (row and column) correspond to the same twelve tiles when the workspace has been rotated by ninety degrees.

A summary flowchart is shown with processing commencing at step 720 when a rotate request is received. At step 730, the current rows and columns are identified by the process shown in FIG. 6 along with the row and column locations and stored in memory area 740 (memory area being a combination of column data 625 and row data 665 shown in FIG. 6). Returning to FIG. 7, at step 750, the current row and column of each tile (as described in FIG. 6) is identified and the identified row/column is stored as the “current” row/column in memory area 422. At step 760, the values corresponding to the various rows and columns (e.g., pixel locations) are swapped so that the current value of row 1 (e.g., 120 pixels) becomes the new value of column 1 and so on. Likewise, the current value of each column, such as column 1 being at 106 pixels, becomes the new value of each row, with row 1 now being at 106 pixels. At step 770, the column and row location values swapped. For example, current column 1 becomes new row 1, current column 2 becomes new row 2, etc. and current row 1 becomes new column 2, current row 2 becomes new column 2, etc. So, taking tile D for example, the current row/column values are 3,1 and the new row/column values are 1,3. At step 780, each tile (A through L) is rotated ninety degrees in the opposite direction as the workspace rotation. In the example shown, the workspace is rotated ninety degrees counterclockwise, so each tile is rotated ninety degrees clockwise.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A machine-implemented method comprising:
receiving a workspace rotation request to rotate a workspace displayed on a display screen, and wherein the workspace includes a plurality of visual tiles that are displayed in a grid layout of one or more columns and one or more rows;
identifying a current aspect ratio of the display screen;
retrieving a current row value and a current column value associated with each of the visual tiles;
inverting the current aspect ratio, the inverting resulting in a new aspect ratio of the display screen;
rotating each of the plurality of visual tiles ninety degrees;
setting a new row value associated with each of the visual tiles to the current column value;
setting a new column value associated with each of the visual tiles to the current row value; and
displaying each of the rotated plurality of visual tiles on the display screen at the new row value and new column value set for each of the visual tiles using the new aspect ratio.

2. The method of claim 1 further comprising:
identifying a visual grouping of a set of the plurality of visual tiles, wherein the set of visual tiles are adjacent to each other; and
visually grouping the set of visual tiles at the new row values and new column values using the new aspect ratio.

3. The method of claim 2 wherein the visual presentation is performed by displaying a visual outline around the set of visual tiles.

4. The method of claim 1 further comprising:
determining whether the workspace is one of a plurality of workspaces;
in response to determining that the workspace is one of a plurality of workspaces:
visually presenting one or more horizontal scroll features on the display screen, wherein the horizontal scroll features are displayed using the new aspect ratio.

5. The method of claim 1 further comprising:
visually presenting a toolbar in the new aspect ratio, wherein the toolbar is presented on a horizontal side of the display screen in response to a new orientation corresponding to the new aspect ratio being a portrait orientation, and wherein the toolbar is presented on a vertical side of the display screen in response to a new orientation corresponding to the new aspect ratio being a landscape orientation.

6. The method of claim 1 further comprising:
retrieving a current workspace height and a current workspace width corresponding to the display screen operating in the current aspect ratio;
setting a new workspace height to the current workspace width;
setting a new workspace width to the current workspace height;
displaying the workspace using the new aspect ratio and the new workspace height and the new workspace width.

7. The method of claim 1 further comprising:
displaying a rotation tile on the display screen, wherein the workspace rotation request is received by receiving a selection of the rotation tile and wherein the selection of the rotation tile is independent of a current physical orientation of the display screen.

8. An information handling system comprising:
one or more processors;
a memory coupled to at least one of the processors;
a display screen accessible by at least one of the processors; and
a set of computer program instructions stored in the memory and executed by at least one of the processors in order to perform actions of:
receiving a workspace rotation request to rotate a workspace displayed on the display screen, and wherein the workspace includes a plurality of visual tiles that are displayed in a grid layout of one or more columns and one or more rows;
identifying a current aspect ratio of the display screen;
retrieving a current row value and a current column value associated with each of the visual tiles;
inverting the current aspect ratio, the inverting resulting in a new aspect ratio of the display screen;
rotating each of the plurality of visual tiles ninety degrees;
setting a new row value associated with each of the visual tiles to the current column value;
setting a new column value associated with each of the visual tiles to the current row value; and
displaying each of the rotated plurality of visual tiles on the display screen at the new row value and new column value set for each of the visual tiles using the new aspect ratio.

9. The information handling system of claim 8 wherein the set of computer program instructions are executed by at least one of the processors to perform additional actions comprising:
identifying a visual grouping of a set of the plurality of visual tiles, wherein the set of visual tiles are adjacent to each other; and
visually grouping the set of visual tiles at the new row values and new column values using the new aspect ratio.

10. The information handling system of claim 9 wherein the visual presentation is performed by displaying a visual outline around the set of visual tiles.

11. The information handling system of claim 8 wherein the set of computer program instructions are executed by at least one of the processors to perform additional actions comprising:
determining whether the workspace is one of a plurality of workspaces;
in response to determining that the workspace is one of a plurality of workspaces:
visually presenting one or more horizontal scroll features on the display screen, wherein the horizontal scroll features are displayed using the new aspect ratio.

12. The information handling system of claim 8 wherein the set of computer program instructions are executed by at least one of the processors to perform additional actions comprising:
visually presenting a toolbar in the new aspect ratio, wherein the toolbar is presented on a horizontal side of the display screen in response to a new orientation corresponding to the new aspect ratio being a portrait orientation, and wherein the toolbar is presented on a vertical side of the display screen in response to a new orientation corresponding to the new aspect ratio being a landscape orientation.

13. The information handling system of claim 8 wherein the set of computer program instructions are executed by at least one of the processors to perform additional actions comprising:
retrieving a current workspace height and a current workspace width corresponding to the display screen operating in the current aspect ratio;
setting a new workspace height to the current workspace width;
setting a new workspace width to the current workspace height;
displaying the workspace using the new aspect ratio and the new workspace height and the new workspace width.

14. The information handling system of claim 8 wherein the set of computer program instructions are executed by at least one of the processors to perform additional actions comprising:
displaying a rotation tile on the display screen, wherein the workspace rotation request is received by receiving a selection of the rotation tile and wherein the selection of the rotation tile is independent of a current physical orientation of the display screen.

15. A program product stored in a machine readable storage medium, comprising program code that, when executed by an information handling system, causes the information handling system to perform actions comprising:
receiving a workspace rotation request to rotate a workspace displayed on a display screen, and wherein the workspace includes a plurality of visual tiles that are displayed in a grid layout of one or more columns and one or more rows;
identifying a current aspect ratio of the display screen;
retrieving a current row value and a current column value associated with each of the visual tiles;
inverting the current aspect ratio, the inverting resulting in a new aspect ratio of the display screen;
rotating each of the plurality of visual tiles ninety degrees;
setting a new row value associated with each of the visual tiles to the current column value;
setting a new column value associated with each of the visual tiles to the current row value; and
displaying each of the rotated plurality of visual tiles on the display screen at the new row value and new column value set for each of the visual tiles using the new aspect ratio.

16. The program product of claim 15 wherein the program code, when executed by the information handling system, causes the information handling system to perform additional actions comprising:
identifying a visual grouping of a set of the plurality of visual tiles, wherein the set of visual tiles are adjacent to each other; and
visually grouping the set of visual tiles at the new row values and new column values using the new aspect ratio.

17. The program product of claim 15 wherein the program code, when executed by the information handling system, causes the information handling system to perform additional actions comprising:
determining whether the workspace is one of a plurality of workspaces;
in response to determining that the workspace is one of a plurality of workspaces:
visually presenting one or more horizontal scroll features on the display screen, wherein the horizontal scroll features are displayed using the new aspect ratio.

18. The program product of claim 15 wherein the program code, when executed by the information handling system, causes the information handling system to perform additional actions comprising:
visually presenting a toolbar in the new aspect ratio, wherein the toolbar is presented on a horizontal side of the display screen in response to a new orientation corresponding to the new aspect ratio being a portrait orientation, and wherein the toolbar is presented on a vertical side of the display screen in response to a new orientation corresponding to the new aspect ratio being a landscape orientation.

19. The program product of claim 15 wherein the program code, when executed by the information handling system, causes the information handling system to perform additional actions comprising:
retrieving a current workspace height and a current workspace width corresponding to the display screen operating in the current aspect ratio;
setting a new workspace height to the current workspace width;
setting a new workspace width to the current workspace height;
displaying the workspace using the new aspect ratio and the new workspace height and the new workspace width.

20. The program product of claim 15 wherein the program code, when executed by the information handling system, causes the information handling system to perform additional actions comprising:
displaying a rotation tile on the display screen, wherein the workspace rotation request is received by receiving a selection of the rotation tile and wherein the selection of the rotation tile is independent of a current physical orientation of the display screen.
